(19) United States
(12) Patent Application Publication
(10) Pub. No.: US 2012/0106127 A1
(43) Pub. Date: May 3, 2012

(54) LIGHT EMITTING DEVICE

(75) Inventors: Yasushi HATTORI, KANAGAWA-KEN (JP); Masaki TOHYAMA, KANAGAWA-KEN (JP); Junichi KINOSHITA, EHIME-KEN (JP); Yoji KAWASAKI, EHIME-KEN (JP); Yuji TAKEDA, EHIME-KEN (JP); Misaki UENO, EHIME-KEN (JP)

(73) Assignees: HARISON TOSHIBA LIGHTING CORP., IMABARI-SHI (JP); KABUSHIKI KAISHA TOSHIBA, TOKYO (JP)

(21) Appl. No.: 13/285,686

(22) Filed: Oct. 31, 2011

(30) Foreign Application Priority Data
Nov. 2, 2010 (JP) 2010-246692

(51) Int. Cl. F21V 8/00; F21V 9/16

(52) U.S. Cl. 362/84

(57) ABSTRACT

A light emitting device includes a light source capable of emitting emission light, a first phosphor layer and an optical waveguide. A first phosphor layer has at least a first surface and a second surface on an opposite side of the first surface, extends in a light guiding direction, and is capable of absorbing the emission light and emitting first wavelength converted light having a longer wavelength than the emission light. The optical waveguide has a reflector. And the optical waveguide has an input surface of the emission light, a reflection surface being in contact with the first surface of the first phosphor layer and provided on a surface of the reflector, and an output surface spaced from the first phosphor layer. The reflection surface and the output surface extend in the light guiding direction.

### CROSS-REFERENCE TO RELATED APPLICATIONS

This application is based upon and claims the benefit of priority from the prior Japanese Patent Application No. 2010-246692, filed on Nov. 2, 2010; the entire contents of which are incorporated herein by reference.

### FIELD

Embodiments described herein relate generally to a light emitting device.

### BACKGROUND

Emission light in the ultraviolet-to-visible wavelength range can be mixed with wavelength converted light emitted from phosphor particles having absorbed this emission light to obtain e.g. white light or incandescent color.

As a light emitting device of this type, for instance, an SMD (surface mounted device) structure is known. In the SMD structure, the chip of a nitride light emitting element is covered with a sealing layer including transparent resin mixed with phosphor particles.

In the light emitting device of the SMD type, the light emitting element is covered with a phosphor-containing sealing layer. Part of blue light from the light emitting element excites phosphor particles, which emit yellow light as wavelength converted light. The other part of the blue light is transmitted through the sealing layer or scattered. The yellow light and the blue light are mixed into artificial white light. Beams of the artificial white light are emitted in all directions. Among them, the light beam directed toward the mounting member bonded with the chip is difficult to sufficiently reflect toward the light extraction side. This results in optical loss due to multiple reflections occurring inside the light emitting device. Thus, in the structure of the light emitting element covered with the phosphor-containing sealing layer, there is a limit to increasing the efficacy (in units of lm/W) of the light source.

### BRIEF DESCRIPTION OF THE DRAWINGS

FIG. 1A is a schematic perspective view of a light emitting device according to a first embodiment, and FIG. 1B is a schematic sectional view taken along line A-A;

FIG. 2 is a schematic sectional view of a light emitting device according to a reference example;

FIG. 3 is a graph showing the dependence of the relative emission intensity of the yellow phosphor on the temperature,

FIG. 4 is a schematic perspective view of a light emitting device according to a second embodiment;

FIG. 5A is a schematic sectional view of the light emitting device according to the second embodiment taken along line B-B, and FIG. 5B is a schematic sectional view of a variation;

FIG. 6 is a graph showing the dependence of the relative excitation intensity of the blue phosphor on the wavelength;

FIG. 7 is a schematic perspective view of the optical waveguide of a light emitting device according to a third embodiment;

FIG. 8 is a schematic view of a light emitting device according to a fourth embodiment;

FIG. 9A is a schematic plan view of a light emitting device according to a fifth embodiment. FIG. 9B is a schematic sectional view taken along line D-D;

FIG. 10 is a schematic perspective view of a fog lamp using the light emitting device of this embodiment;

FIG. 11 is a schematic view of a light bulb using the light emitting device of this embodiment;

FIG. 12 is a schematic sectional view of a street light using the light emitting device of this embodiment;

FIG. 13A is a schematic perspective view of a light emitting device according to a sixth embodiment, FIG. 13B is a schematic sectional view taken along line E-E, and FIG. 13C is a graph of light distribution characteristic;

FIG. 14 is a schematic perspective view of a light emitting device according to a comparative example;

FIG. 15A is a schematic perspective view of a light emitting device according to a variation of the sixth embodiment, FIG. 15B is a schematic sectional view taken along line F-F, and FIG. 15C is a graph of light distribution characteristic;

FIG. 16A is a schematic perspective view of a light emitting device according to a seventh embodiment, FIG. 16B is a schematic sectional view taken along line H-H, and FIG. 16C is a graph of light distribution characteristic; and

FIG. 17A is a schematic view describing the brightness distribution of an LCD-BLU using the light emitting device according to the seventh embodiment. FIG. 17B is a schematic view describing the brightness distribution of an LCD-BLU using a CCFL (cold cathode fluorescent lamp).

### DETAILED DESCRIPTION

In general, according to one embodiment, a light emitting device includes a light source capable of emitting emission light, a first phosphor layer and an optical waveguide. A first phosphor layer has at least a first surface and a second surface on an opposite side of the first surface, extends in a light guiding direction, and is capable of absorbing the emission light and emitting first wavelength converted light having a longer wavelength than the emission light. The optical waveguide has a reflector. And the optical waveguide includes an input surface of the emission light, a reflection surface being in contact with the first surface of the first phosphor layer and provided on a surface of the reflector, and an output surface spaced from the first phosphor layer. The reflection surface and the output surface extend in the light guiding direction.

Embodiments of the invention will now be described with reference to the drawings.

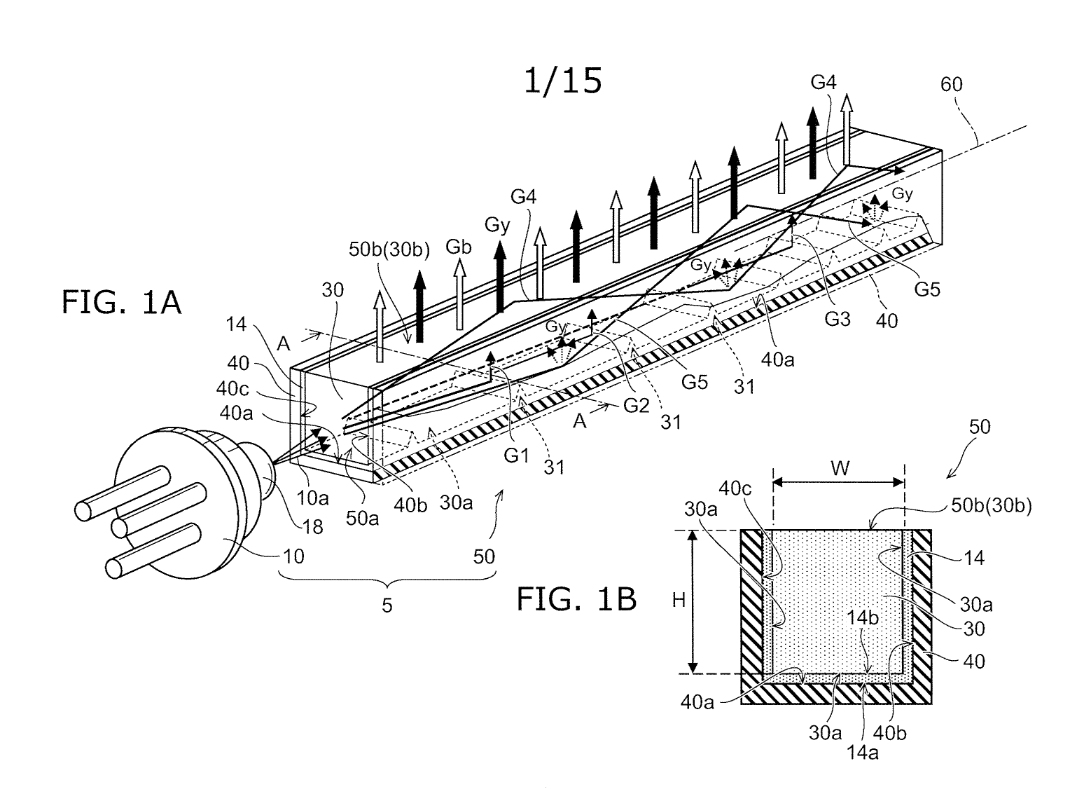

FIG. 1A is a schematic perspective view of a light emitting device according to a first embodiment. FIG. 1B is a schematic sectional view taken along line A-A.

The light emitting device 5 includes a light source 10, an optical waveguide 50 spaced from the light source 10, and a first phosphor layer 14.

The light source 10 inputs emission light 10a to the input surface 50a of the optical waveguide 50. The light source 10 can be e.g. an LED (light emitting diode) or LD (laser diode) made of a nitride semiconductor material capable of emitting emission light 10a in the ultraviolet-to-visible wavelength range. In the case of LD, the size of the emission spot can be set to 10 μm or less, and the emission light 10a can be narrowed to e.g. a vertical full width at half maximum of 30 degrees and a horizontal full width at half maximum of 10 degrees. Thus, a sharp beam is easily obtained. This facilitates converging the light with a lens 18 having a diameter of several mm so as to be reliably inputted into the optical waveguide 50. Here, in the example shown in FIGS. 1A and 1B, the LD chip is mounted on a CAN package. However, the package is not limited thereto.

The optical waveguide 50 includes a reflector 40. The optical waveguide 50 includes at least an input surface 50a of the emission light 10a, reflection surfaces 40a, 40b, 40c each provided on the inner surface of the reflector 40, and an output surface 50b. The reflection surfaces 40a, 40b, 40c and the output surface 50b of the optical waveguide 50 extend in the light guiding direction 60. Furthermore, the optical waveguide 50 can include an optical waveguide body 30 including at least a first surface 30a and a second surface 30b. Then, the emission light 10a can be guided into the optical waveguide 50 more reliably. The optical waveguide body 30 is made of a transmissive material such as transparent resin and glass. Alternatively, the optical waveguide body 30 may be an air layer. Here, in FIG. 1A, in the reflector 40, the lower portion on the reflection surface 40b side (the portion of the dashed line) is omitted.

For instance, the width W of the optical waveguide body 30 can be set to 1.5 mm, and the height H can be set to 1.5 mm. The length of the optical waveguide 50 along the light guiding direction 60 can be set to e.g. 60 mm. Thus, the first phosphor layer 14 is caused to extend along the light guiding direction 60. This can decrease the density of light from the spaced light source 10 and suppress saturation in the phosphor. The shape of the optical waveguide 50 is not limited to a rectangular solid. Here, the input surface 50a is defined as the surface of the optical waveguide body 30 opposed to the light source 10. Even in the case where the optical waveguide body 30 is an air layer, the input surface 50a is assumed to lie at the same position.

The reflector 40 can be made of a metal material such as aluminum, and its surface can be mirror-finished into reflection surfaces 40a, 40b, 40c. Alternatively, the reflector 40 may be made of a reflective sheet laminated to a material having low reflectance.

Incident light beams G1-G5 are inputted from the input surface 50a of the optical waveguide body 30 and guided at different angles in the optical waveguide body 30 toward the surface opposed to the input surface 50a. The first phosphor layer 14 can absorb the incident light beams G1-G5 and emit first wavelength converted light Gy having a longer wavelength than the emission light 10a. In the case where the wavelength of the emission light 10a lies in the ultraviolet-to-blue wavelength range, the first phosphor layer 14 can include silicate-based yellow phosphor particles. The first surface 14a of the first phosphor layer 14 is provided along the light guiding direction 60 in contact with or close to e.g. the reflection surfaces 40a, 40b, 40c. The first phosphor layer 14 can be formed by dispersing phosphor particles in e.g. transparent resin or glass, which is then applied to the inner surface of the reflector 40 and cured.

Alternatively, phosphor particles may be provided on the reflection surfaces 40a, 40b, 40c by direct coating or printing. In this case, small gaps may occur among the phosphor particles, and the reflection surfaces 40a, 40b, 40c may be exposed through the gaps. Nevertheless, the layer of the phosphor particles is herein referred to as first phosphor layer 14.

Here, in FIG. 1B, the output surface 50b is assumed to represent the second surface 30b of the optical waveguide body 30. Even in the case where the optical waveguide body 30 is an air layer, among the surfaces including the upper end of the reflector 40, the surface in no contact with the first phosphor layer 14 and capable of transmitting the emission light 10a and the first wavelength converted light Gy is referred to as output surface. That is, the first phosphor layer 14 is provided so as to extend in the light guiding direction 60 while being spaced from the output surface 50b.

Next, the operation of the optical waveguide 50 is described with reference to FIG. 1A. The emission light 10a from the light source 10 is introduced from the input surface 50a. The incident light beams G1, G2, G3 introduced into the optical waveguide body 30 are reflected by V-grooves 31 provided on the first surface 30a of the optical waveguide body 30 and outputted from the output surface 50b to the outside. In this case, the intensity distribution of the outputted emission light can be controlled by appropriately selecting the shape and spacing of the V-grooves 31.

The introduced incident light beams G4, G5 travel along the light guiding direction 60 while repeating reflections. That is, at the second surface 30b, the light is reflected by e.g. total reflection at the interface between the optical waveguide body 30 and the outside. At the first surface 30a, the light is reflected by the optical waveguide body 30, or by the reflection surfaces 40a, 40b, 40c.

If the refractive index difference between the optical waveguide body 30 and the first phosphor layer 14 is reduced, the reflection at the interface is reduced. This facilitates input of the incident light beams G4, G5 into the first phosphor layer 14. Part of the incident light G4, G5 excites the first phosphor layer 14 and generates first wavelength converted light Gy. The first wavelength converted light Gy includes a component emitted from the first phosphor layer 14, transmitted through the optical waveguide body 30 without the intermediary of the reflector 40, and emitted from the output surface 50b, and a component reflected by the reflector 40, transmitted through the first phosphor layer 14 and the optical waveguide body 30, and emitted from the output surface 50b. These components of the first wavelength converted light Gy can be combined and uniformly distributed along the light guiding direction 60 on the output surface 50b.

Among the incident light beams G4, G5, the light beam not contributing to excitation is reflected by the reflection surface 40a and further travels along the light guiding direction 60. Here, the emission light 10a can travel along the light guiding direction 60 while repeating reflections also between the reflection surfaces 40b, 40c. Then, the emission light 10a is directly outputted, or excites the first phosphor layer 14.

The emission light 10a can be blue light with a wavelength of 450 nm, and the first phosphor layer 14 can be made of yellow phosphor of a silicate material. Then, the first wavelength converted light Gy can be yellow light with a wavelength near 560 nm. As a result, the light emitting device 5 emits blue light Gb and yellow light Gy from the output surface 50b. Thus, the light emitting device 5 serves as a linear light source capable of emitting e.g. artificial white light as mixed light of the blue light Gb and the yellow light Gy.

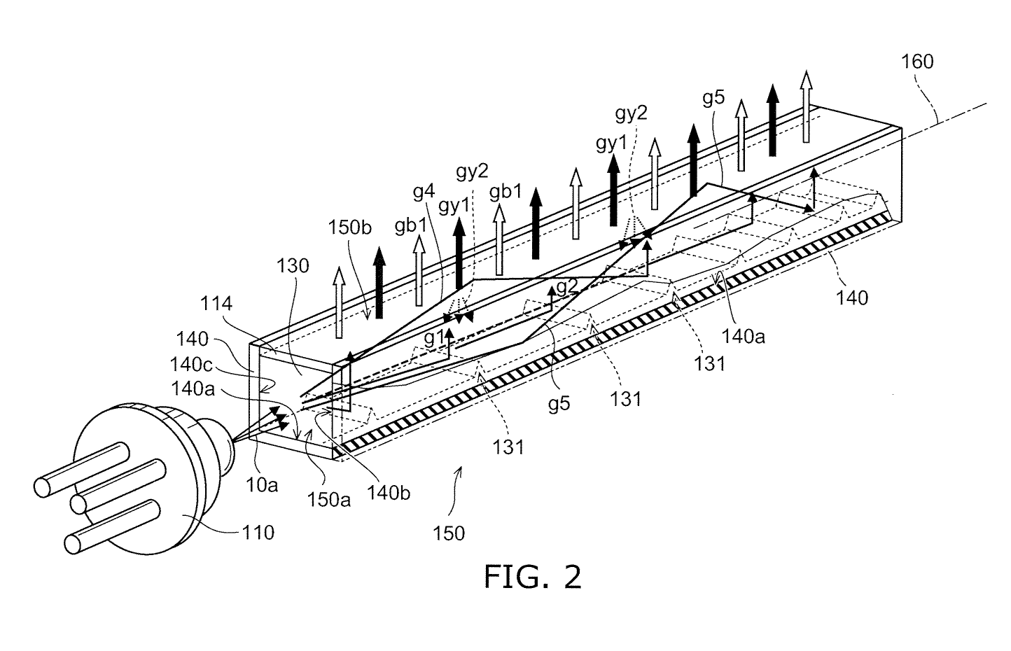

FIG. 2 is a schematic sectional view of a light emitting device according to a reference example.

The light emitting device includes a light source 110, a yellow phosphor layer 114, an optical waveguide 150, and an optical waveguide body 130. The optical waveguide 150 includes a reflector 140. The optical waveguide 150 includes an input surface 150a of emission light, reflection surfaces 140a, 140b, 140c each provided on the surface of the reflector 140, and an output surface 150b. The reflection surfaces 140a, 140b, 140c and the output surface 150b extend in a first direction 160.

Three surfaces of the optical waveguide body 130 are respectively in contact with the reflection surfaces 140a, 140b, 140c. On the remaining one surface of the optical waveguide body 130, the yellow phosphor layer 114 is provided in contact therewith. The upper surface of the yellow phosphor layer 114 constitutes the output surface 150b. V-grooves 131 are provided on the lower surface of the optical waveguide body 130 and can reflect the emission light from the light source 110 toward the output surface 150b.

The yellow phosphor layer 114 is excited by irradiation with the emission light from the light source 110 and emits yellow light as wavelength converted light. Among the beams of the wavelength converted light, the light beam directed upward is denoted by gy1, and the light beam directed downward is denoted by gy2. The yellow light gy1, gy2 is more likely to spread than the emission light from the light source 110. Because the phosphor layer 114 and the reflector 140 are spaced from each other, the yellow light gy2 spread downward further spreads while traveling upward after being reflected by the reflection surface 140a.

Thus, the light spread in the first direction 160 and in the plane orthogonal to the first direction 160 is made more prone to multiple reflections in the optical waveguide 150. For instance, the light is attenuated with Fresnel reflections repeated at the interface between the optical waveguide body 130 and air. Furthermore, the light reflected by the reflection surface 140 is also attenuated by multiple reflections. That is, optical loss increases in the optical waveguide 150 due to multiple reflections including Fresnel reflections.

In contrast, in this embodiment, the first surface 14a of the first phosphor layer 14 is provided in contact with the reflection surfaces 40a, 40b, 40c. The thickness of the first phosphor layer 14 can be made smaller than the height H of the optical waveguide 50. For instance, in the case where the height H of the optical waveguide body 30 is 1.5 mm, the thickness of the first phosphor layer 14 can be set to e.g. 0.2 mm. That is, a thin first phosphor layer 14 is provided in contact with the reflection surfaces 40a, 40b, 40c opposite to the output surface 50b. Hence, the spread of the component of the first wavelength converted light Gy reflected by the reflection surface 40a can be reduced and made close to the spread of the directly emitted component of the wavelength converted light Gy. Thus, the spread of the wavelength converted light Gy is suppressed. Hence, the optical loss due to multiple reflections is reduced, and mixed light including artificial white light is emitted efficiently. The first phosphor layer 14 acts so that the wavelength converted light Gy is emitted from the reflection surfaces. Thus, this embodiment can be referred to as being based on phosphor excitation of the reflection type.

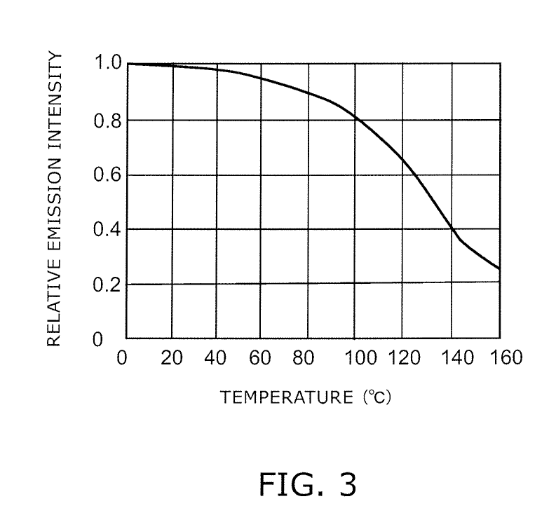

FIG. 3 is a graph showing the dependence of the relative emission intensity of the yellow phosphor on the temperature.

The vertical axis represents relative emission intensity with the emission intensity at 0° C. normalized to 1. The horizontal axis represents temperature (° C.). It is assumed that the yellow phosphor is a silicate phosphor. The relative emission intensity decreases to generally 0.8 at 100° C. and generally 0.4 at 140° C. That is, the yellow phosphor undergoes temperature quenching. For instance, in the case of the light emitting device of the SMD type, the phosphor layer is provided so as to cover the light emitting element chip. This results in large temperature increase and causes the problem of temperature quenching.

In contrast, in this embodiment, the first phosphor layer 14 is spaced from the light emitting element 10. Hence, the temperature increase is suppressed. Furthermore, even if the first phosphor layer 14 absorbs excitation light, heat is easily dissipated through the reflector 40 extending in the light guiding direction 60. Accordingly, the temperature quenching is suppressed, and high emission intensity is easily maintained.

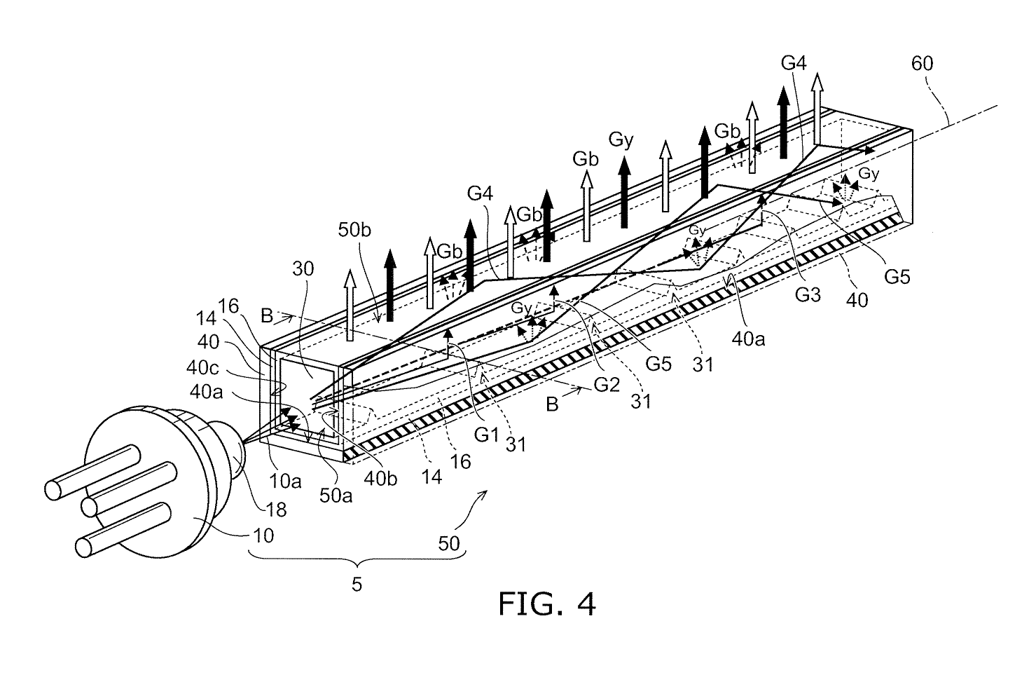

FIG. 4 is a schematic perspective view of a light emitting device according to a second embodiment.

The light source 10 used in this embodiment is an LED or LD made of a nitride semiconductor material capable of emitting blue-violet emission light 10a having a wavelength near 405 nm.

In this description, the term “blue-violet” is defined as the wavelength range of 365 nm or more and shorter than (less than) 410 nm. The term “blue” is defined as the wavelength range of 410 nm or more and 480 nm or less. The term “yellow” is defined as the wavelength range of 540 nm or more and 570 nm or less.

The light emitting device 5 further includes a second phosphor layer 16 provided so as to cover the first phosphor layer 14. The second phosphor layer 16 includes blue phosphor capable of absorbing the emission light 10a and emitting second wavelength converted light Gb. The wavelength of the second wavelength converted light Gb is longer than the blue-violet wavelength of the emission light 10a and shorter than the wavelength of the first wavelength converted light Gy.

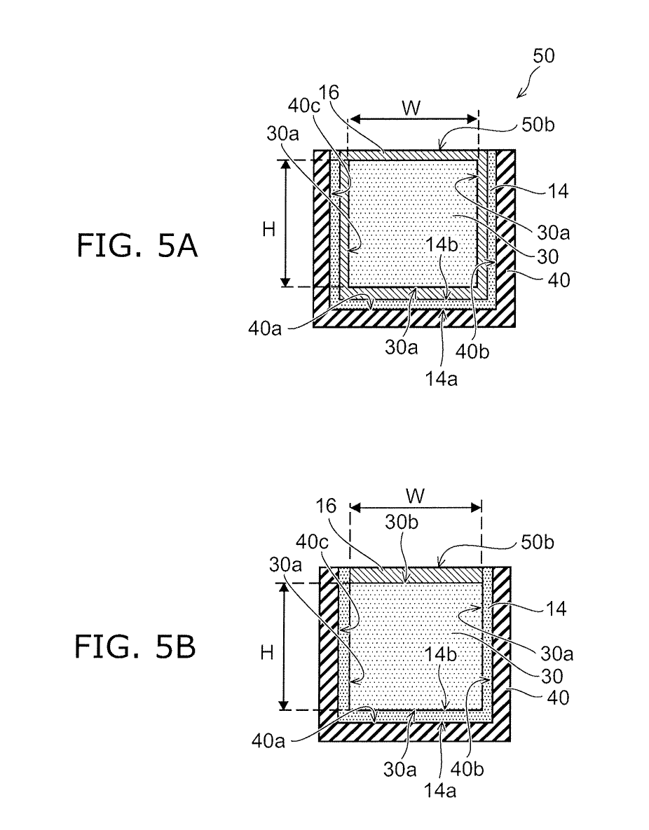

FIG. 5A is a schematic sectional view of the light emitting device according to the second embodiment taken along line B-B. FIG. 5B is a schematic sectional view of a variation.

In FIG. 5A, the second phosphor layer 16 is provided throughout the side surfaces of the optical waveguide body 30. In FIG. 5B, the second phosphor layer 16 includes a first surface and a second surface. The first surface is in contact with the second surface 30b of the optical waveguide body 30. The second surface (output surface 50b) of the second phosphor layer 16 is the rear surface of the second phosphor layer 16. Furthermore, the output surface 50b is a region (with width W) spaced from the first phosphor layer 14.

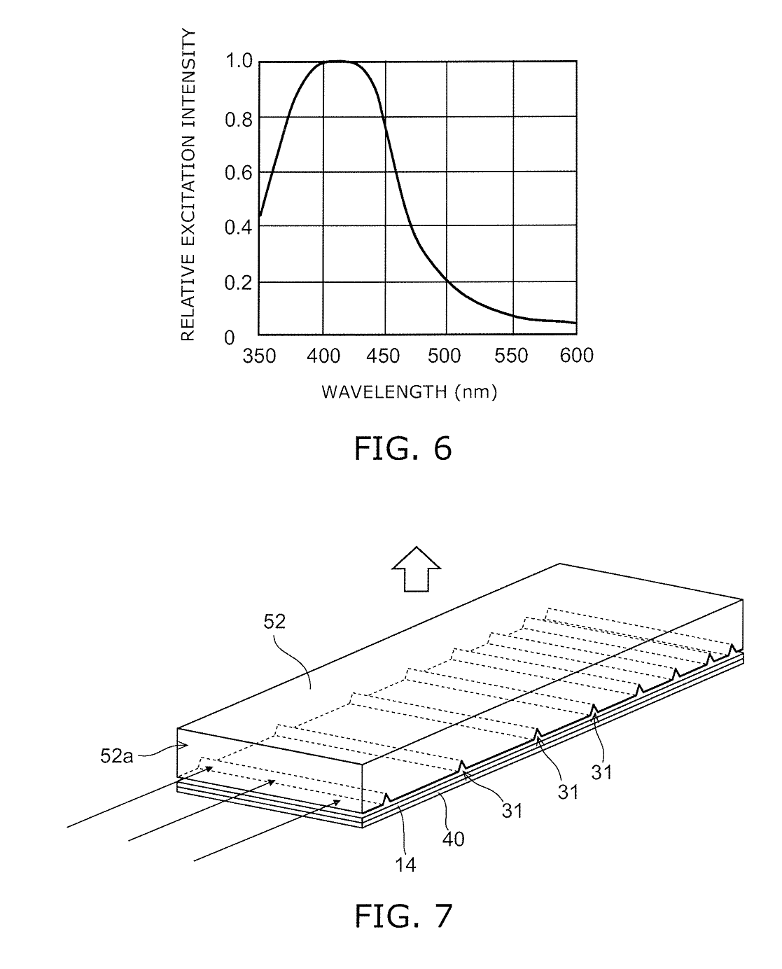

FIG. 6 is a graph showing the dependence of the relative excitation intensity of the blue phosphor on the wavelength.

The vertical axis represents relative excitation intensity, and the horizontal axis represents wavelength (nm). The blue phosphor is excited by emission light having an emission wavelength of 405 nm, and the emission spectrum of the blue phosphor has a peak near 450 nm. As such blue phosphor, for instance, a material made of apatite can be used. If the first wavelength converted light Gy is yellow light having a wavelength near 560 nm, the relative excitation intensity of the blue phosphor at a wavelength of 560 nm is as low as generally 0.05. That is, yellow light is not significantly absorbed by the blue phosphor, and its optical loss can be reduced.

In FIG. 4, incident light beams G1-G5 are inputted from the input surface 50a of the optical waveguide body 30 and travel in different directions in the optical waveguide body 30. In the process of traveling in the optical waveguide body 30, the incident light beams G1, G2, G3 among the incident light beams G1-G5 reach and irradiate part of the second phosphor layer 16 and excite the phosphor in the irradiated region. Thus, the second wavelength converted light Gb is emitted from the output surface 50b.

On the other hand, part of the incident light (G4, G5) is reflected in the irradiated region of the phosphor layer 16 without contributing to excitation of the phosphor. The incident light G4, G5 reaches a different region of the phosphor layer 16 and excites the phosphor, or does not contribute to excitation but travels along the light guiding direction 60 while increasing the excitation-emission region by further repeating reflection. Furthermore, part of the incident light G4, G5 excites the first phosphor layer 14 and generates first wavelength converted light Gy. The first wavelength converted light Gy is emitted from the reflection surface 40a toward the output surface 50b while spreading. If the first phosphor layer 14 includes yellow phosphor and the second phosphor layer 16 includes blue phosphor, then as shown in FIG. 6, the amount of yellow light absorbed by the second phosphor layer 16 is small. Thus, the optical loss is reduced, and mixed light including artificial white light can be obtained efficiently.

FIG. 7 is a schematic perspective view of the optical waveguide of a light emitting device according to a third embodiment.

The light emitting device includes an optical waveguide plate 52 including a plurality of optical waveguides capable of guiding a plurality of emission light beams. Thus, the light emitting device can be used as a planar light source. Incident light to the side surface 52a of the optical waveguide plate 52 may be emission light of an LED converged by a lens. However, use of an LD facilitates converging the light.

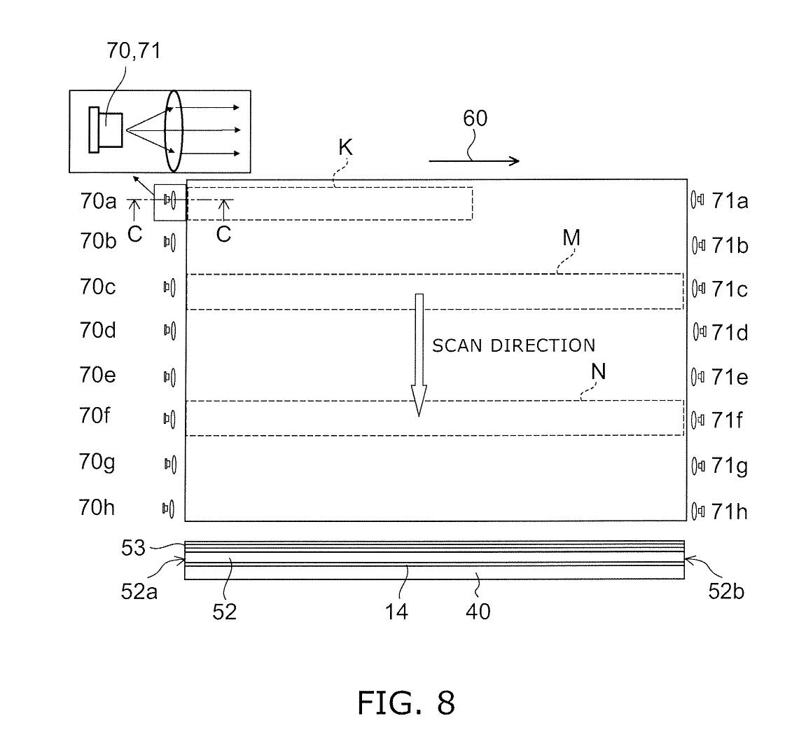

FIG. 8 is a schematic view of a light emitting device according to a fourth embodiment.

The first (yellow) phosphor layer 14 is provided on the reflection surface of the reflector 40. An optical waveguide plate 52 is provided on the first phosphor layer 14. Light sources 70, 71 each composed of eight blue LDs are arranged on both side surfaces 52a, 52b of the optical waveguide plate 52. Each emission light is converged by a lens and introduced into the side surface 52a, 52b.

If the light source 10 is an LD, the blue light introduced from the side surface 52a does not significantly spread. The blue light travels in a band-like pattern while being diffused by an optical film 53 provided on the upper surface of the optical waveguide plate 52. Part of the blue light directed toward the lower surface is turned into yellow light as first wavelength converted light by the first phosphor layer 14 and outputted from the upper surface of the optical film 53. The remaining blue light GB not contributing to excitation is also outputted from the upper surface of the optical film 53 and mixed with the yellow light into artificial white light.

In this case, the optical axis of the light source 70a and the optical axis of the light source 71a can be generally aligned with a line parallel to line C-C. Then, by simultaneous lighting, a band-like artificial white light emitting pattern parallel to the light guiding direction 60 can be obtained. Furthermore, by simultaneous lighting sequentially from the side of the light sources 70a, 71a, scan lighting of the light emitting pattern of band-like regions M, N can be realized. On the other hand, lighting an LD on one side enables local dimming partitioned horizontally into two parts and vertically into eight parts. For instance, if the light source 70a is lighted, only the upper left region K is lighted.

The band-like light emitting pattern facilitating such scan lighting and local dimming is difficult to realize by an LED light source having wide light distribution. More specifically, the light emitting area of an LED is as large as 0.5 mm×0.5 mm. Hence, the size of the converging lens is made large. Furthermore, the shape of the optical waveguide plate needs to be processed in order to suppress the spread of light, which increases the cost.

In contrast, this embodiment uses LDs having small emission spot size. Hence, even with an optical waveguide plate as thin as approximately 2 mm, optical coupling with high coupling efficiency is easily realized. That is, the light emitting device has high productivity, and consequently facilitates cost reduction.

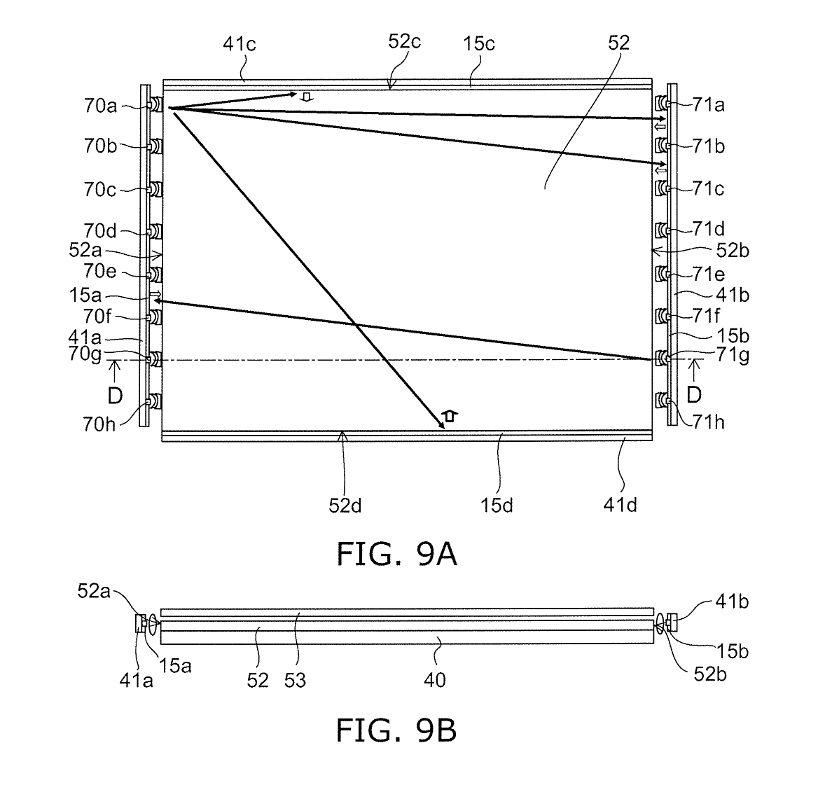

FIG. 9A is a schematic plan view of a light emitting device according to a fifth embodiment. FIG. 9B is a schematic sectional view taken along line D-D.

On the lower surface side of the optical waveguide plate 52, the first phosphor layer is not provided, but only the reflector 40 is placed. Eight light sources 70 made of blue LD are arranged on the side surface 52a of the optical waveguide plate 52, and eight light sources 71 are arranged on the side surface 52b. Blue light from the light source 70 is converged in the cross section of FIG. 9B, passes through a lens for widening the light distribution in the plane of FIG. 9A, and then is introduced from the side surface 52a. On the reflector 41a with the eight light sources 70 arrayed thereon, a first phosphor layer 15a is provided on the portion except the bonding region of the light sources 70.

On the reflector 41b with the eight light sources 71 arrayed thereon, a first phosphor layer 15b is provided on the portion except the bonding region of the light sources 71. Furthermore, a reflector 41c provided with a first phosphor layer 15c is provided close to the side surface 52c, and a reflector 41d provided with a first phosphor layer 15d is provided close to the side surface 52d.

Blue light emitted from the light source 70 is inputted from the side surface 52a and spread in the optical waveguide plate 52. The blue light is then uniformly outputted from the upper surface of the optical waveguide plate 52 and also outputted from the side surface 52b. The blue light outputted from the side surface 52b excites the first phosphor layer 15b provided on the reflector 41b. The wavelength converted yellow light is inputted from the side surface 52b to the optical waveguide plate 52. As a result, artificial white light occurs in a wide region on the side surface 52b side and contributes to planar light emission. Also on the side surface 52a side, artificial white light can be obtained likewise.

If an LED array light source of the edge light type is used as a light source, its optical output is far lower than that of LD. Hence, a larger number of LEDs need to be arranged. This increases absorption loss of blue light on the opposite side. Furthermore, the area for providing the first phosphor layer is decreased, and yellow light cannot be emitted sufficiently.

In contrast, this embodiment uses blue LDs. Thus, the bonding area of blue LDs is small relative to the total area of the reflector 41. This reduces the absorption loss due to blue LDs and facilitates increasing the application area of the first phosphor layer.

The blue light propagated in the optical waveguide plate 52 to the side surface 52c excites the first phosphor layer 15c to generate yellow light. Thus, artificial white light occurs in a wide region on the side surface 52c side. The blue light propagated in the optical waveguide plate 52 to the side surface 52d excites the first phosphor layer 15d to generate yellow light. Thus, artificial white light occurs in a wide region on the side surface 52d side. The optical loss in the reflectors 41c, 41d is low because no light source is provided thereon.

By such a structure, blue light and yellow light inputted from the four side surfaces 52a, 52b, 52c, 52d of the optical waveguide plate 52 are outputted through the optical film 53. Thus, artificial white light can be obtained with high efficacy. The chromaticity of the artificial white light is determined as mixture of the blue component directly outputted from the optical waveguide plate 52, the yellow component wavelength-converted near the side surfaces, and the reflected component of the blue light. The color unevenness near the blue LD can be alleviated by decreasing the pattern of the optical waveguide plate 52 in that portion. In this embodiment, the first phosphor layer 15 is applied only on the side surface of the optical waveguide plate 52. Hence, its amount can be reduced, enabling cost reduction.

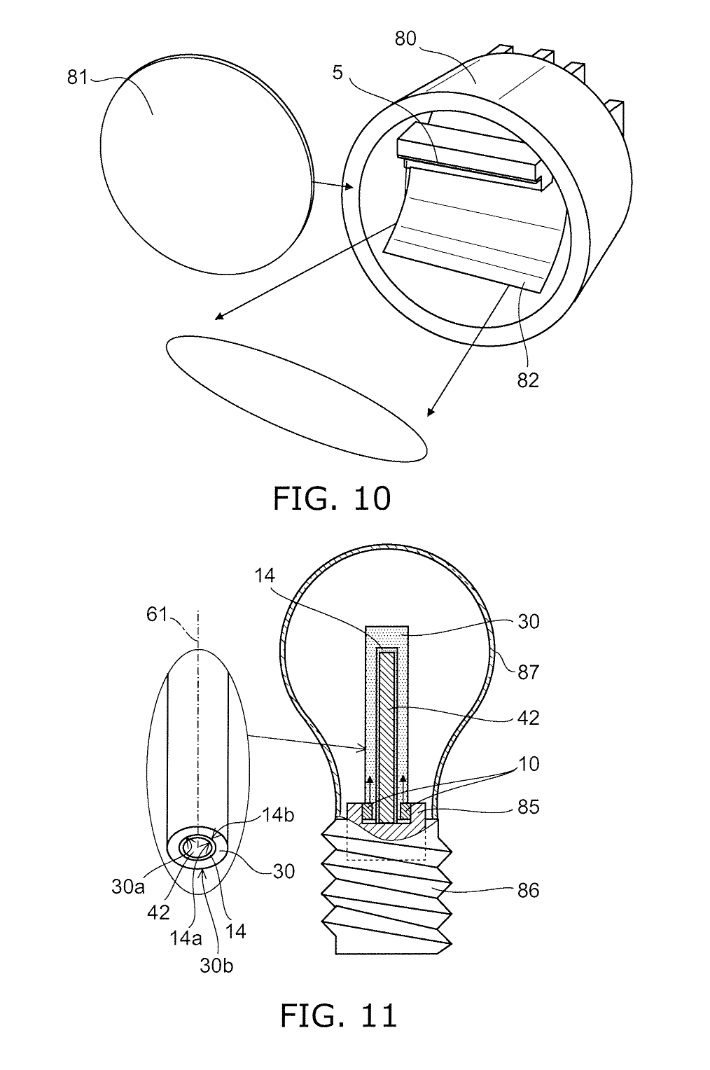

FIG. 10 is a schematic perspective view of a fog lamp using the light emitting device of this embodiment.

In this example, the light emitting device 5, which is a linear light source of one of the first and second embodiments, is applied to a fog lamp. As compared with an array light source based on spaced LEDs, a linear light source can be realized with high efficacy and no granular feeling. The light emitting device 5 is placed in a lamp body 80. The emission light of the light emitting device 5 can be smoothly radiated as a beam via a reflector 82. The front side is covered with a transparent cap 81. This structure is also applicable to high intensity head lamps. Furthermore, by changing the arrangement of a plurality of linear light sources, this structure is applicable to spot lights for various purposes.

FIG. 11 is a schematic view of a light bulb using the light emitting device of this embodiment.

The light bulb includes a light source 10, a first phosphor layer 14, a reflector 42, and an optical waveguide body 30. The optical waveguide body 30 is made of e.g. a glass tube sealed at its cylindrical tip. A first (yellow) phosphor layer 14 is applied to the first surface 30a, or inner edge, of the optical waveguide body (glass tube) 30. The first surface 14a, or inside, of the first phosphor layer 14 is in contact with the white reflector 42. The light source 10 is a blue LD. The blue light is introduced into the portion of the glass tube having an annular cross section, and guided along the light guiding direction 61 lying on the central axis of the glass tube.

In this case, the reflection surface is the surface of the columnar reflector 42 packed inside. The first phosphor layer 14 is provided so as to surround the surface of the reflector 42. Thus, artificial white light is emitted radially (in all directions of 360 degrees) from the second surface 30b, or outer edge, of the optical waveguide body 30. A bulb 87 and a base 86 are provided so as to enclose this linear light source. Thus, a light bulb having the same outline as a filament light bulb can be realized. Here, a blue-violet LD can also be used as the light source 10. In this case, blue phosphor is provided on the outer edge of the glass tube. As compared with the structure of using an LED as a light source and applying phosphor entirely inside the bulb, the amount of phosphor used is reduced, and the efficacy is increased more easily.

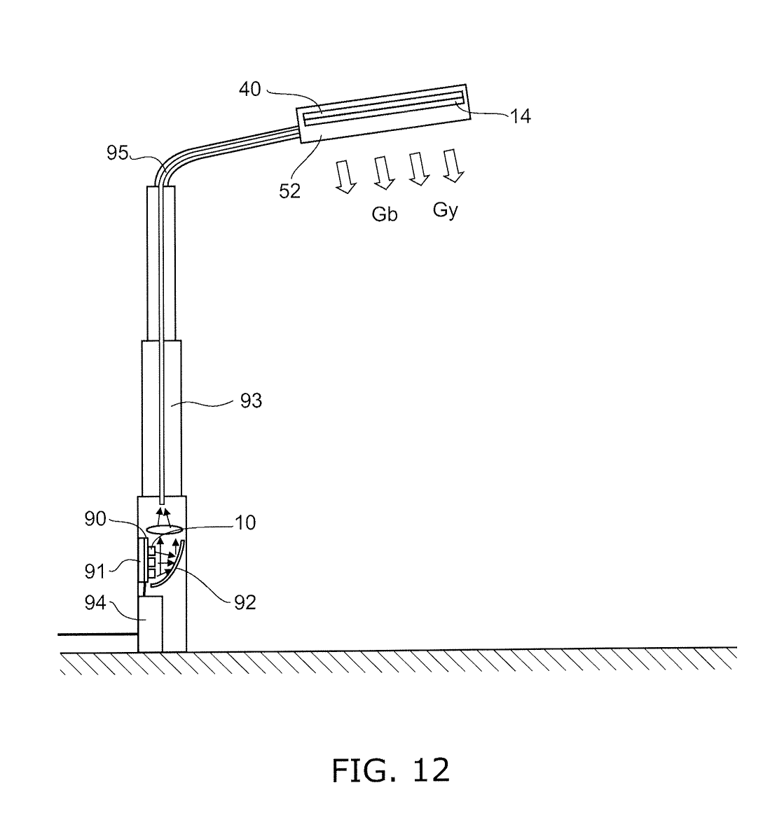

FIG. 12 is a schematic sectional view of a street light using the light emitting device of this embodiment.

The street light includes a light source 10 made of e.g. an excitation LD array, an optical fiber 95, an optical waveguide plate 52, a first phosphor layer 14, a reflector 40, a heat radiator 91, and a power supply 94. The reflector 40 in contact with the first phosphor layer 14, and the optical waveguide plate 52 constitute an optical section. The optical section is provided in the upper portion of the post 93 of the street light. Thus, the upper portion of the street light can be made lightweight.

On the other hand, the light source 10, the heat radiator 91, and the power supply 94 are provided inside the lower portion of the post 93. This facilitates maintenance of the light source 10 and the power supply 94. The emission light from the light source 10 is converged by a lens 92, passes through e.g. a lens and the optical fiber 95, and is introduced into the side surface of the optical waveguide plate 52. Thus, artificial white light can be emitted. Here, the light source 10 may be an LED array or OLED (organic LED). Furthermore, the emission light from the light source 10 provided in the lower portion of the post 93 may be propagated in air instead of using the optical fiber.

The first to fifth embodiments provide light emitting devices facilitating efficient wavelength conversion using phosphors. These light emitting devices can be used for e.g. illumination devices, display devices, fog lamps, light bulbs, and street lights.

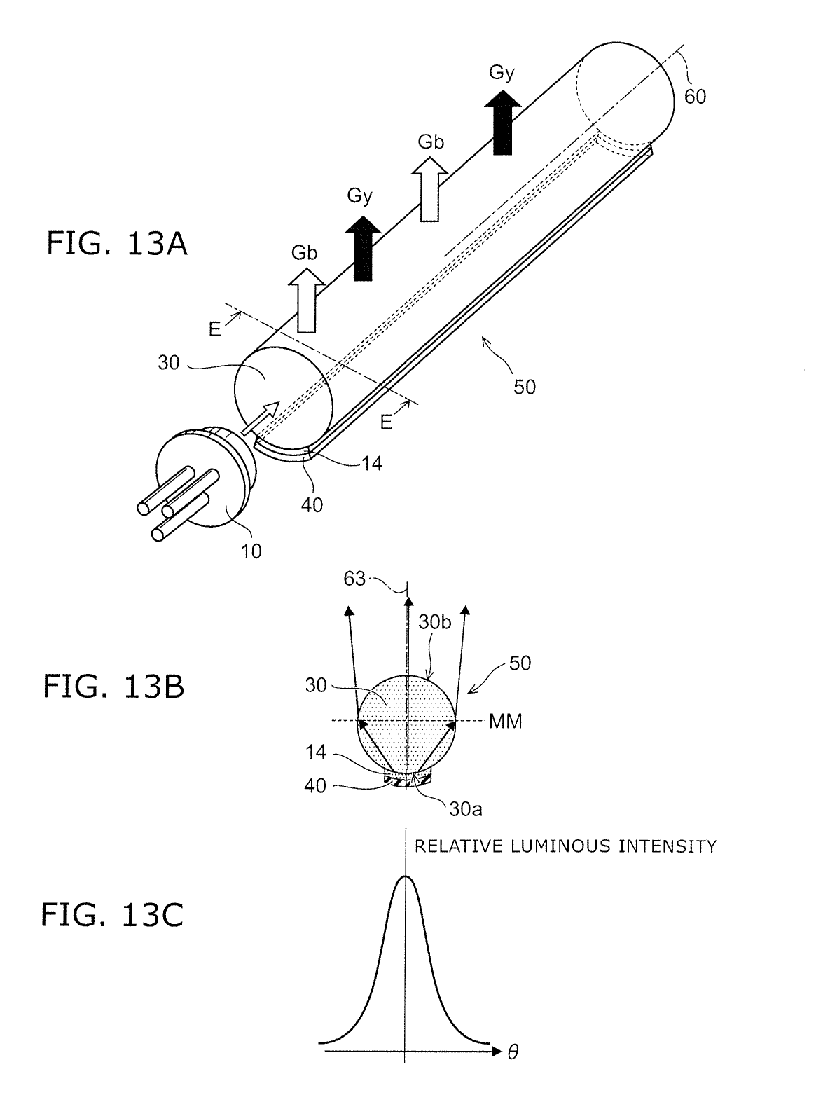

FIG. 13A is a schematic perspective view of a light emitting device according to a sixth embodiment. FIG. 13B is a schematic sectional view taken along line E-E. FIG. 13C is a graph of light distribution characteristic.

The light emitting device includes a light source 10 in the blue-violet-to-blue wavelength range, an optical waveguide 50 spaced from the light source 10, and a first phosphor layer 14 made of yellow phosphor. The optical waveguide 50 includes a reflector 40 and an optical waveguide body 30. The light source 10 can be an LED or LD. If the light source 10 is an LD, a sharp beam is obtained. This facilitates optical coupling to the slim linear optical waveguide body 30.

For instance, the optical waveguide body 30 is made of a glass rod having a circular cross section with a diameter of 2 mm, and having a length of 600 mm. The optical waveguide body 30 has a first surface 30a on the lower surface side or lateral surface side. The first phosphor layer 14 is provided on the first surface 30a of the optical waveguide body 30. The width of the first phosphor layer 14 is 0.2 mm, smaller than the width (equal to the diameter, 2 mm) of the optical waveguide body 30. Furthermore, the reflector 40 having e.g. the same width as the first phosphor layer 14 is provided on the lower surface of the first phosphor layer 14.

The emission light from the light source 10 is inputted to the optical waveguide body 30. Part of the incident light irradiates the first phosphor layer 14, which emits yellow light Gy as first wavelength converted light. The emission light and the first wavelength converted light are directly outputted from the output surface, or outputted from the optical waveguide body 30 after being reflected by the surface of the first phosphor layer 14 and the reflector 40. As a result, a linear light source capable of emitting artificial white light can be realized. Here, V-grooves may be provided on the lower surface side of the optical waveguide body. However, the first wavelength converted light from the slim first phosphor layer 14 and the reflected light from the slim reflector 40 include many components spread and totally reflected at the side surface of the optical waveguide body 30. Thus, without V-grooves, the light is easily propagated along the light guiding direction 60.

This structure facilitates increasing the wavelength conversion efficiency because no optical absorber exists near the first phosphor layer 14 and the reflector 40. That is, the efficacy of the light emitting device is determined by the reflectance and absorption coefficient of the thin first phosphor layer 14 and the reflector 40, and the wavelength conversion efficiency of the phosphor layer.

As shown in FIG. 13B, the first wavelength converted light emitted from the first phosphor layer 14 having a narrow width is emitted from the second surface 30b of the optical waveguide body 30 directly, or after being reflected by the reflection surface. The second surface 30b is the surface of the optical waveguide body 30 above the dashed line MM. The circular cross-sectional shape of the optical waveguide body 30 functions as a collimating lens for the slim light emitting region for emitting artificial white light. The emission distribution can be controlled along the light guiding direction 60 by changing the shape of the first phosphor layer 14 and the reflector 40. FIG. 13C shows the light distribution characteristic representing the relative value of luminous intensity as viewed in the direction inclined by angle θ from the optical axis 63. As shown in FIG. 13C, the light distribution characteristic is steep.

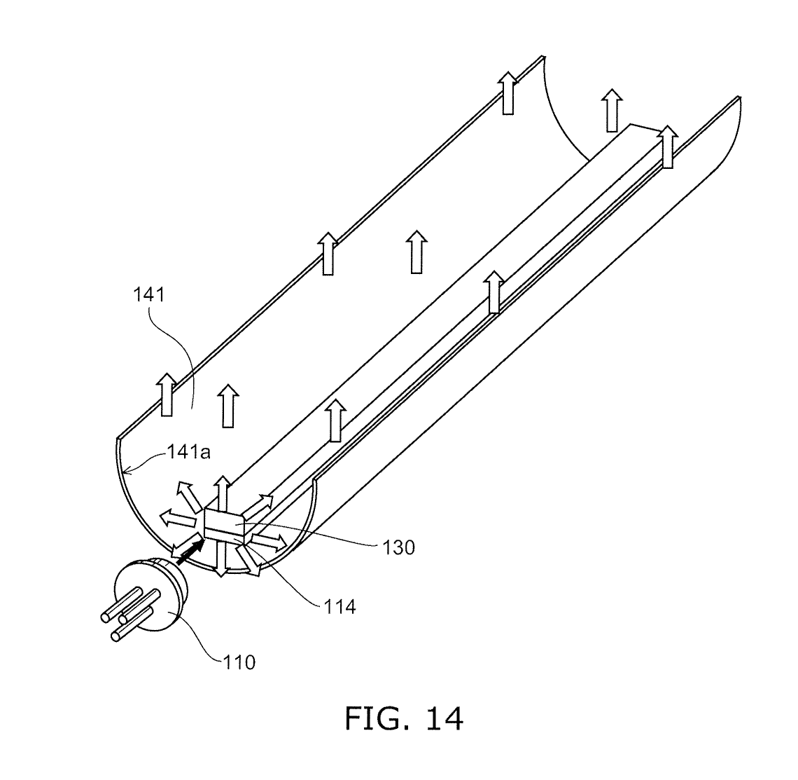

FIG. 14 is a schematic perspective view of a light emitting device according to a comparative example.

The light emitting device according to the comparative example includes a light source 110, an optical waveguide body 130, a phosphor layer 114 provided along the optical waveguide body 130, and a reflector 141. In this case, the light distribution characteristic exhibits a Lambert distribution broadened on one side. To narrow the light distribution characteristic, for instance, an additional optical system including a concave mirror 141a on the surface of the reflector 141 needs to be provided on the side opposite to the output side. For instance, the cross section of the concave mirror 141a is shaped like a parabola, and the emission spot is placed at its focus. This facilitates converging the light. Alternatively, an additional optical system including a converging lens may be provided on the output surface side. However, the width of these optical systems is larger than the width of the optical waveguide body 130. This increases the size of the light emitting device.

In contrast, in the sixth embodiment, the structure of integrating the optical waveguide body 30 with the converging lens facilitates downsizing of the light emitting device. For instance, high input efficiency can be achieved while reducing the thickness of the optical waveguide plate to e.g. 2.5 mm. Such a linear light source can be used for e.g. an LCD-BLU (liquid crystal display's back light unit). Furthermore, the thickness of the optical waveguide plate can be further reduced by narrowing the width of the optical waveguide body 30.

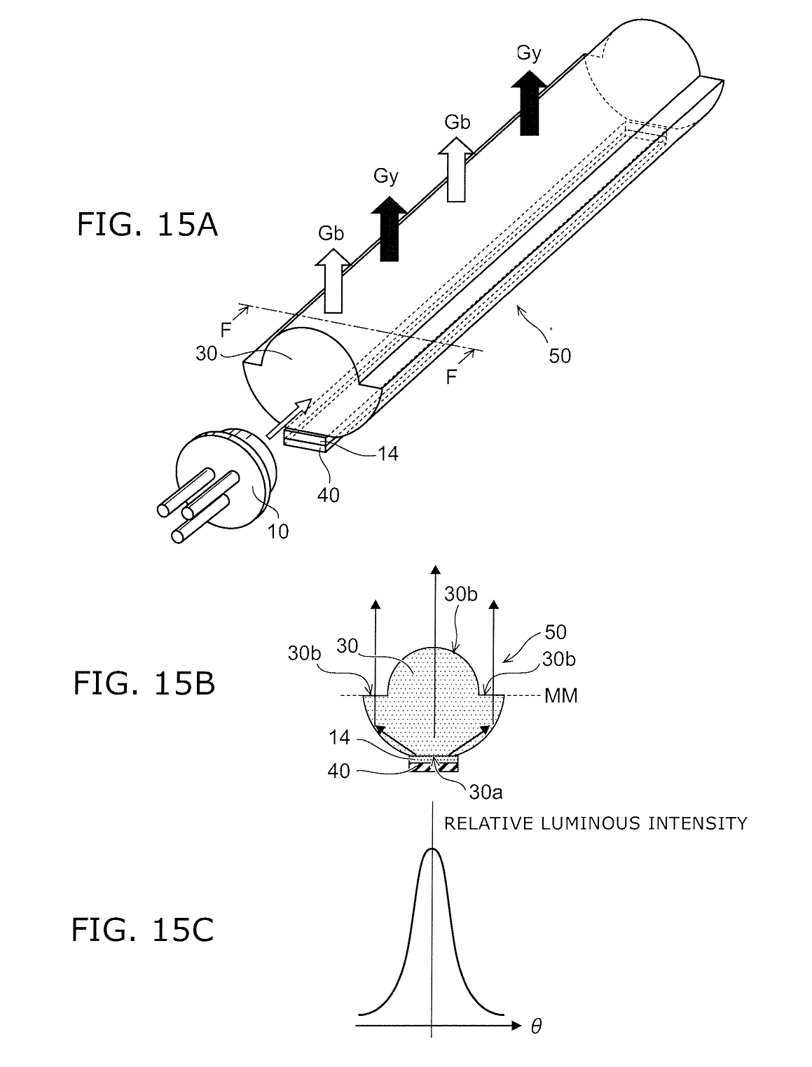

FIG. 15A is a schematic perspective view of a light emitting device according to a variation of the sixth embodiment. FIG. 15B is a schematic sectional view taken along line F-F. FIG. 15C is a graph of light distribution characteristic.

The first wavelength converted light is totally reflected by the curved surface having a parabolic cross section provided on the lower surface side of the optical waveguide body 30. Then, the first wavelength converted light is converged by the curved surface on the upper surface side and emitted from the second surface 30b of the optical waveguide body 30. Hence, a steep light distribution characteristic as shown in FIG. 15C is obtained.

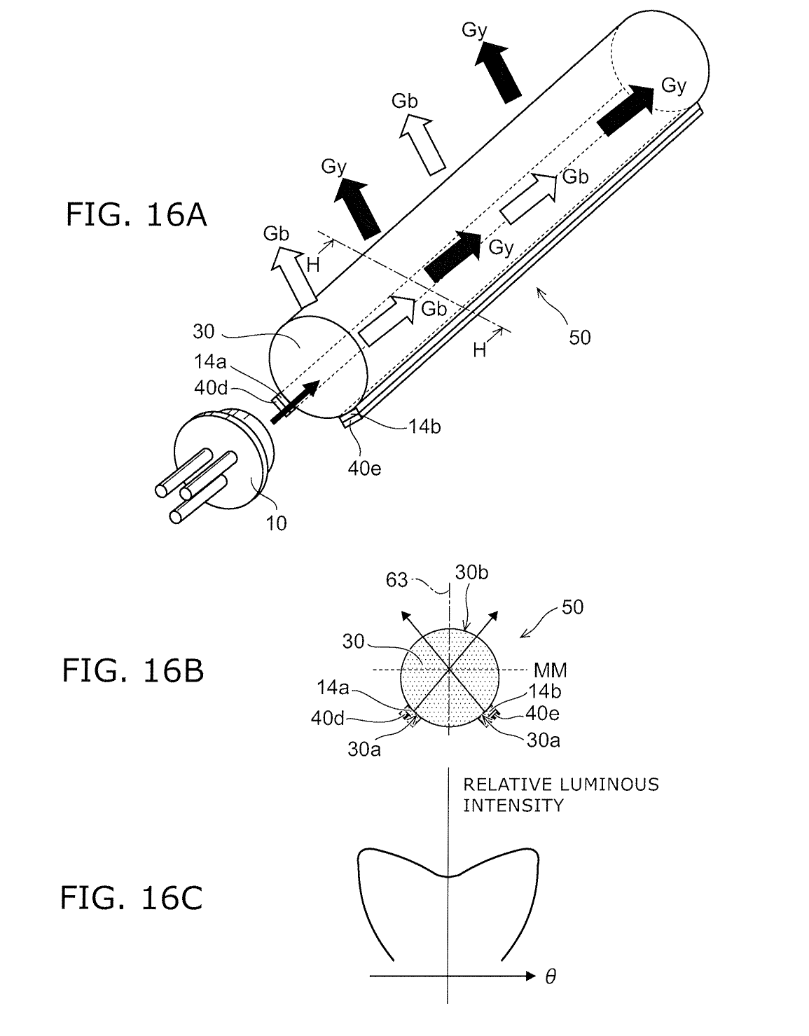

FIG. 16A is a schematic perspective view of a light emitting device according to a seventh embodiment. FIG. 16B is a schematic sectional view taken along line H-H. FIG. 16C is a graph of light distribution characteristic.

The first phosphor layer 14 includes two regions 14a, 14b. The reflector 40 includes two regions 40d, 40e. The optical waveguide body 30 can have a circular cross section. Then, the first wavelength converted light beams from the two regions are converged in different directions. That is, each first wavelength converted light beam is directed e.g. obliquely upward, and outputted from the second surface 30b of the optical waveguide body 30 above the dashed line MM. Thus, for instance, a bimodal light distribution characteristic as shown in FIG. 16C can be realized.

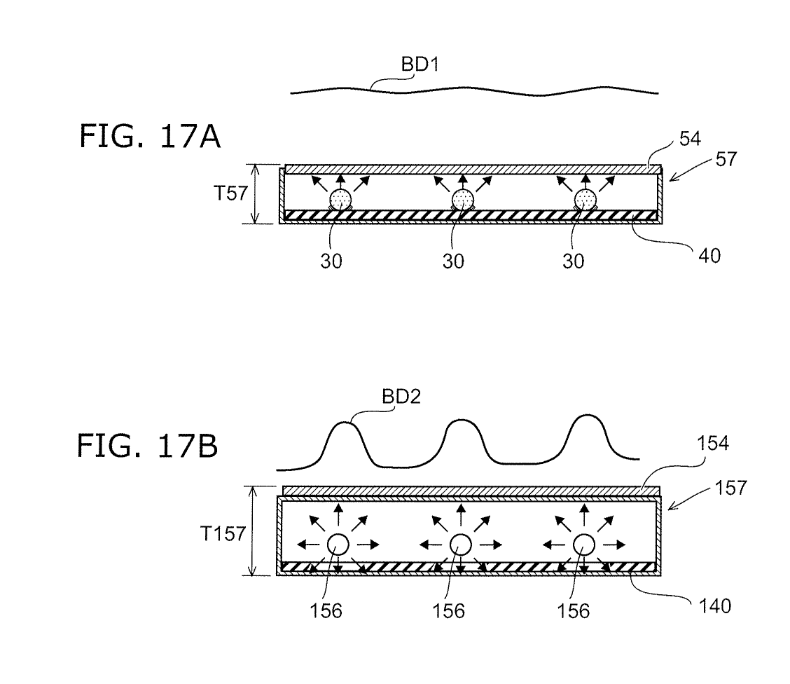

FIG. 17A is a schematic view describing the brightness distribution of an LCD-BLU using the light emitting device according to the seventh embodiment. FIG. 17B is a schematic view describing the brightness distribution of an LCD-BLU using a CCFL (cold cathode fluorescent lamp).

The light emitting device according to the seventh embodiment has a bimodal light distribution characteristic. Even if the thickness T57 of the back light unit 57 is made small, the brightness distribution BD1 above the diffusion plate 54 can be made uniform. On the other hand, use of the CCFL 156 produces peaks in the brightness distribution BD2 above the light emitting region as shown in FIG. 17B. Hence, it is difficult to make the brightness distribution BD2 uniform unless the diffusion plate 154 is distanced from the CCFL 156. That is, the thickness T157 of the back light unit 157 is enlarged.

As described above, the sixth and seventh embodiments and the variation associated therewith can realize a very slim linear light source capable of controlling the light distribution.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A light emitting device comprising:
a light source capable of emitting emission light;
a first phosphor layer including at least a first surface and a second surface on an opposite side of the first surface, extending in a light guiding direction, and being capable of absorbing the emission light and emitting first wavelength converted light having a longer wavelength than the emission light; and
an optical waveguide having a reflector and including an input surface of the emission light, a reflection surface being in contact with the first surface of the first phosphor layer and provided on a surface of the reflector, and an output surface spaced from the first phosphor layer, the reflection surface and the output surface extending in the light guiding direction.

2. The device according to claim 1, further comprising:
an optical waveguide body having a rectangular cross section with a first surface and a second surface extending in the light guiding direction,
the first surface of the optical waveguide body being in contact with the second surface of the first phosphor layer, and
the second surface of the optical waveguide body lying on the output surface side.

3. The device according to claim 2, wherein the first surface of the optical waveguide body is provided with a groove capable of reflecting the emission light toward the output surface.

4. The device according to claim 2, wherein the optical waveguide body is one of glass, transparent resin, and air.

5. The device according to claim 2, wherein
the emission light has a wavelength in a blue light wavelength range, and
the first wavelength converted light has a wavelength in a yellow light wavelength range.

6. The device according to claim 2, further comprising:
a second phosphor layer having a first surface and a second surface and being capable of absorbing the emission light and emitting second wavelength converted light having a wavelength longer than wavelength of the emission light and shorter than wavelength of the first wavelength converted light,
the first surface of the second phosphor layer being provided in contact with the second surface of the optical waveguide body,
the second surface of the second phosphor layer constituting the output surface,
the wavelength of the emission light lying in a blue-violet light wavelength range,
the wavelength of the first wavelength converted light lying in a yellow light wavelength range, and
the wavelength of the second wavelength converted light lying in a blue light wavelength range.

7. The device according to claim 6, wherein the second phosphor layer covers all side surfaces of the optical waveguide body.

8. The device according to claim 1, wherein the light source is a semiconductor laser element.

9. A light emitting device comprising:
a light source capable of emitting emission light;
a tubular optical waveguide body including an input surface configured to receive the emission light, a first surface constituting an inner edge, and a second surface constituting an outer edge, the first surface and the second surface extending in a light guiding direction;
a first phosphor layer including at least a first surface and a second surface on an opposite side of the first surface, extending in the light guiding direction, and being capable of absorbing the emission light and emitting first wavelength converted light having a longer wavelength than the emission light, the second surface being in contact with the first surface of the optical waveguide body; and
a reflector being in internal contact with the first surface of the first phosphor layer and extending in the light guiding direction,
the second surface of the optical waveguide body lying on the output surface side and externally emitting the emission light and the first wavelength converted light.

10. The device according to claim 9, wherein the optical waveguide body is one of glass, transparent resin, and air.

11. The device according to claim 9, wherein
the emission light has a wavelength in a blue light wavelength range, and
the first wavelength converted light has a wavelength in a yellow light wavelength range.

12. The device according to claim 9, wherein the light source is a semiconductor laser element.

13. A light emitting device comprising:
a light source capable of emitting emission light;
a first phosphor layer including at least a first surface and a second surface on an opposite side of the first surface, extending in a light guiding direction, and being capable of absorbing the emission light and emitting first wavelength converted light having a longer wavelength than the emission light; and
an optical waveguide body including an input surface of the emission light, a first surface in contact with the first surface of the first phosphor layer, and an output surface spaced from the first phosphor layer, the optical waveguide body extending in the light guiding direction,
the output surface having a lens curve in a cross section orthogonal to the light guiding direction and having a wider width than the first phosphor layer, and the first wavelength converted light and the emission light being converged and emitted from the output surface.

14. The device according to claim 13, wherein
the first phosphor layer includes a first region and a second region spaced from each other,
the first and second regions have narrower widths than the optical waveguide body, and
wavelength converted light from the first region and wavelength converted light from the second region are converged in different directions by the optical waveguide body.

15. The device according to claim 14, wherein the light emitted from the output surface has a bimodal light distribution characteristic.

16. The device according to claim 13, further comprising:
a reflector in contact with the second surface of the phosphor layer.

17. The device according to claim 13, wherein the optical waveguide body includes part of a circle in the cross section orthogonal to the light guiding direction.

18. The device according to claim 13, wherein the optical waveguide body is one of glass, transparent resin, and air.

19. The device according to claim 13, wherein
the emission light has a wavelength in a blue light wavelength range, and
the first wavelength converted light has a wavelength in a yellow light wavelength range.

20. The device according to claim 13, wherein the light source is a semiconductor laser element.
